(19) United States
(12) Patent Application Publication
(10) Pub. No.: US 2015/0186882 A1
(43) Pub. Date: Jul. 2, 2015

(54) METHOD AND APPARATUS FOR MANAGING TRANSACTIONS THROUGH CREDIT OR DEBIT CARDS

(71) Applicant: JUSP S.P.A., Cagliari (CA) (IT)

(72) Inventors: Jacopo Vanetti, Sesto Calende (IT); Giuseppe Nicola Saponaro, Castelletto Ticino (IT); Luca Vaccaro, Pioltello (IT); Emanuele Spiriti, Arona (IT)

(21) Appl. No.: 14/409,957

(22) PCT Filed: Jun. 20, 2013
(86) PCT No.: PCT/IB2013/055083

§ 371 Date: Dec. 19, 2014

(30) Foreign Application Priority Data
Jun. 20, 2012 (IT) MI2012A001085

(51) Int. Cl. G06Q 20/40; G06Q 20/20; G06Q 20/22; G06Q 20/34

(52) U.S. Cl. CPC G06Q 20/401; G06Q 20/341; G06Q 20/202; G06Q 20/204; G06Q 20/22; G06Q 2220/00

(57) ABSTRACT

An apparatus for managing transactions through credit or debit cards includes a POS (101) for the credit or debit cards, adapted to be connected to a terminal (102) via an audio channel of the terminal, the apparatus including a component for reading the credit or debit cards of the EMV type; at least one user interface for entering secret codes, transaction amounts, and for displaying the amounts; a component for processing transaction-related data through packet organization and FSK modulation/demodulation, and for bidirectional transmission via the audio channel; at least one processing unit placed in an anti-tamper secure area, for the transactions which is also adapted to handle a connection to a central management server, and a component for encrypting the data.

### FIELD OF THE INVENTION

The present invention relates to a method and apparatus for managing transactions through credit or debit cards.

### PRIOR ART

The use of credit cards and payment (credit/debit) cards is strongly increasing as a result of the technological development, which guarantees higher reliability, as a result of the comfort and of anti-money laundering regulations that limit payments by cash.

These cards are used for different types of transaction: from the purchase of goods or services to financial transactions.

Information necessary for each transaction is stored and encrypted in different manners depending on the type of card, for example cards with magnetic stripe or smart-card; as regards cards with magnetic stripe information is stored by modifying the magnetism of the particles on the magnetic stripe, on the contrary, smart cards integrate and use a EMV chip. EMV (Europay, MasterCard and VISA) is a standard for using smart-cards, POS terminals and cashpoint cards for authenticating credit and debit card transactions.

A card with EMV chip has all the structures necessary for observing this standard.

The POS (Point of sale) currently on the market are mainly designed for being used inside the stores and not for activities in motion.

This approach has led to the fact that POS have been always designed with non-pocket size; moreover, due to intrinsic technological limits, it has never been possible to make a “miniature” POS, with also all the security and reliability characteristics required.

Conventional POS use the embedded modem for the connection to the processing centre of the bank, or of the bank group, that provides the service. It is in charge of the authentication of the request, which, in affirmative case, is processed.

In the present description and in the claims below, POS means not only a device that reads the data stored into a smart-card, but a set of technical characteristics comprising the modes for extracting the data from the card, how the device is designed, how the device is assembled, how the device is initialized and all the security systems implemented by it. In order to be defined as POS these characteristics have to be in compliance with regulations and standards imposed by the authorized bodies.

EMV-CO and PCI can be considered by way of example.

A payment card reader means any device able to read the data inside a credit card and it has not to be in compliance with any regulations (ex. EMV-CO, PCI, etc.) regarding one or more of the following aspects: the design of the article, the manufacturing of the article, the type and level of security, the protocol used.

The development of mobile phones of new generation (Smart Phone) has provided the tools necessary for managing a payment request and for interfacing with the processing centre. A card reader can be connected to a smart-phone and send information stored in the cards. A universal data channel provided on all the last generation mobile phones has been defined in the audio interface. This provides a secure channel for information passage but it is limited in the speed. This type of limit is very binding if data of high size are desired to be transferred.

For this reason, nowadays, the portable payment card readers of known type that use the audio channel for exchanging data, are restricted to transactions on magnetic stripe payment cards. The latter are a type of card not so much used all over the Europe, therefore a device of this type would be not much useful and it would cover only a small percentage of transactions, but mainly it would not be in compliance with the specific regulations that regulate payment operations in European countries. Therefore it is considerably important to create a POS managing chip cards.

The prior art does not provide POS apparatuses to use the audio channel for exchanging data with other devices.

The Applicant believes that this is mainly due to the complexity of transmitting a payment on an audio carrier with a high amount of data (RSA certificates, encoded data, etc.) with numerous bi-directional exchanges. A further obstacle in using an audio channel in this specific field is the difficulty in handling data on audio channel above all due to the different sound cards provided in the devices with which the POS has to interface.

### SUMMARY OF THE INVENTION

Therefore the object of the present invention is to provide a method and an apparatus for managing transactions through credit or debit cards intended to overcome all said drawbacks.

The invention particularly relates to an apparatus for managing transactions through credit or debit cards, comprising a POS connected to a mobile phone via its audio channel.

The choice of the audio channel for exchanging data is considered to be advantageous by the Applicant for several reasons, including:
all the smartphones/tablet computers are provided with an audio port, and therefore it is very simple to physically connect the apparatus of the invention with a smartphone and/or with a tablet computer;
other types of physical connections are not so widespread (e.g. the so called “micro USB”, despite being rather widespread, nowadays are not provided in Apple® products);
further problems related to the interoperability with Apple® products regards the fact that in order to establish a connection with an external device it is necessary to install an Apple® proprietary chip and to acquire an appropriate user license (MFi—made for iPod, made for iPhone, made for iPad); by using the audio port it is possible to bypass this type of obstacles;
a connectivity of the Bluetooth® type has several types of problems:
   a) there are different types of Bluetooth® connections, which are not always compatible with each other;
   b) Bluetooth® technology involves considerable consumptions from the electric point of view, therefore considerably reducing the battery life of mobile devices;
   c) setting the Bluetooth® communication between two devices (so called “pairing”) could not be obvious, above all for unskilled users;
   d) the fact that data, whose confidentiality is crucial, are transmitted over the air would make the system more vulnerable to security attacks;
   e) Bluetooth® technology further involves not negligible costs due to software libraries that have to be acquired and to hardware modules that have to be installed in the devices;
   f) in the past Bluetooth® standard has been affected by problems about security of embedded devices (smart phone, table computer, etc.), leading to security attacks by ill-intentioned people to the detriment of the owners of the article. These types of vulnerabilities are public and widely spread, a famous intrusion technique is called “bluejacking”.
   Considering the above, the Applicant believes that the use of the audio jack involves considerable advantages both as regards the security point of view, and as regards the easiness of connection to a very wide range of apparatuses. Should an imaginary subject decide to break into the system and to acquire data in a non-authorized manner, the subject should be able to:
      physically connect to the device at the article by means of a cable,
      demodulate the audio stream without knowing a priori the algorithms and the parameters used for the modulation;
      decrypt the data that, however, are encrypted by security systems such as: RSA, 3DES, etc.

By means of the present invention, in addition to provide a type of connection as an alternative to conventional POS, the smart phones, or in general the portable devices equipped with a POS connected to the audio port, can offer additional services for the management of payments and for displaying sales statistics that make the system something more than a payment method.

The present invention relates to an apparatus for managing transactions through credit or debit cards, which comprises a POS adapted to be connected to a terminal via an audio channel of said terminal, the apparatus comprising: means for reading said credit or debit cards of the EMV type; at least one user interface for entering secret codes, transaction amounts, and for displaying said amounts; means for processing transaction-related data through packet organization and FSK modulation, and for bidirectional transmission via said audio channel; at least one processing unit, placed in an anti-tamper secure area, for said transactions which is also adapted to handle a connection to a central management server; means for encrypting said data.

The present invention relates also to a method for managing transactions through credit or debit cards by means of the previous apparatus, said method comprising the steps of: managing the communication between said POS, and said terminal via said audio channel of said terminal; processing said transaction-related data, comprising secret codes, transaction amounts, through packet organization and FSK modulation, and bidirectional transmission via said audio channel; entering transaction amounts into said terminal, and displaying said amounts on said POS; entering secret codes in said POS.

The present invention particularly relates to a method and an apparatus for managing transactions through credit or debit cards, as better described in the claims, which are an integral part of the present description.

### BRIEF DESCRIPTION OF THE FIGURES

Further objects and advantages of the present invention will be clear from the following detailed description of one embodiment thereof (and its variants) and from the annexed drawings given by way of example and not as a limitation, wherein:

FIG. 1 is the structure of the system of the present invention showing its main components.

FIG. 2 is the flow chart of the operations carried out by the mobile device or POS during a transaction.

FIG. 3 is the flow chart of the operations carried out by the POS during a transaction.

FIG. 4 is the flow chart of the operations carried out by the server during a transaction.

FIG. 5 is the flow chart of the process for receiving messages through audio port on the mobile device side.

FIG. 6 is the flow chart of the process for receiving messages through audio port on the POS side.

FIG. 7 is the flow chart of the process for receiving messages through audio both on the mobile device side and on the POS side.

FIG. 8 is an example of a block diagram for implementing the electronic circuit incorporated in the POS of the invention.

FIGS. 9a and 9b are two views of an example for making the housing of said POS.

The same numbers and the same reference letters in the figures denote the same elements or components.

### DETAILED DESCRIPTION OF THE EMBODIMENTS

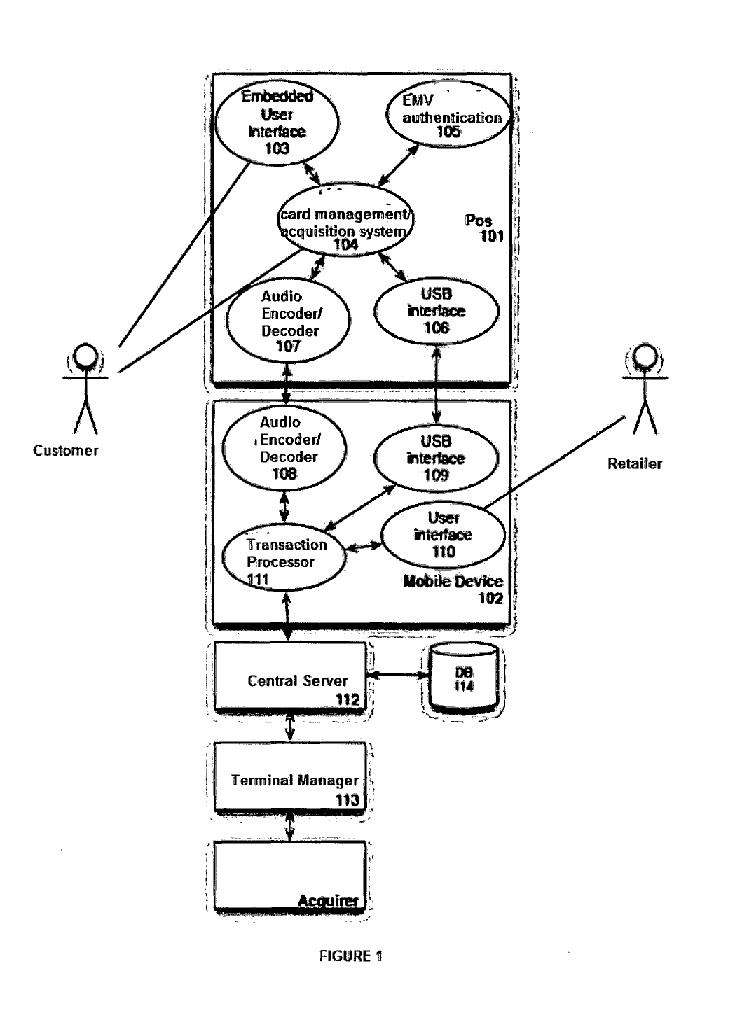

FIG. 1 shows the block diagram of the structure of the device of the invention and the relationship among its components. The two main blocks are composed of a POS (101) and a software application provided on the mobile device (Mobile Device 102).

The system is able to carry out any financial transactions from credit or debit card. Cards must have an EMV chip, as defined above, of the type known per se.

The POS (101) is miniaturized such to be portable and it communicates with the mobile device (102) that will manage the transaction by using an encryption method for making the data transfer more secure.

The POS 101 comprises a user interface for entering the secret code and for displaying information about the transaction (103). Moreover there is provided a system for acquiring and managing the data of the card in use (104).

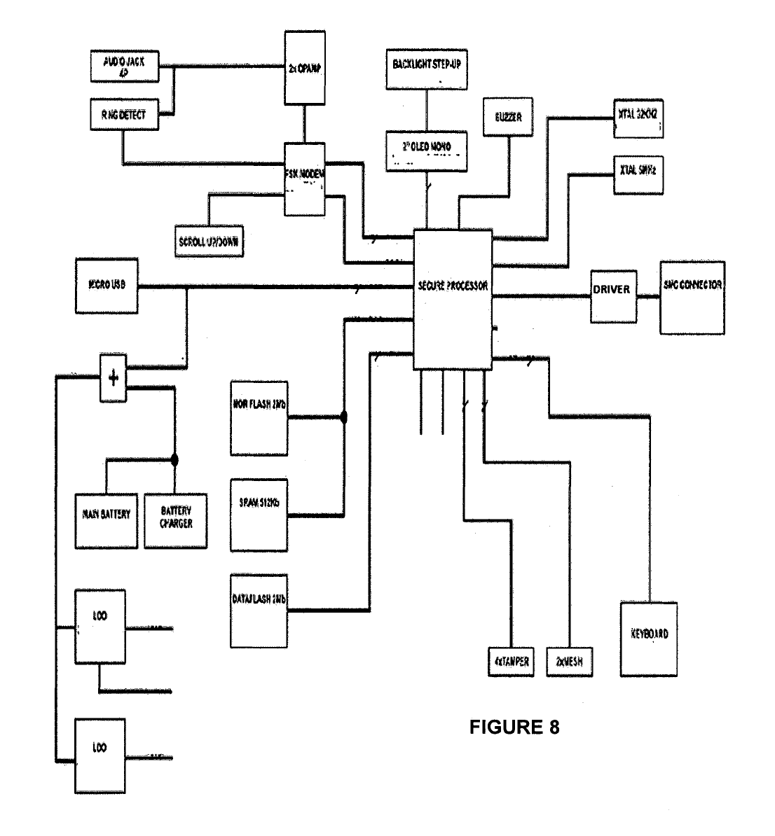

With reference also to FIG. 8, an embodiment of the POS is described.

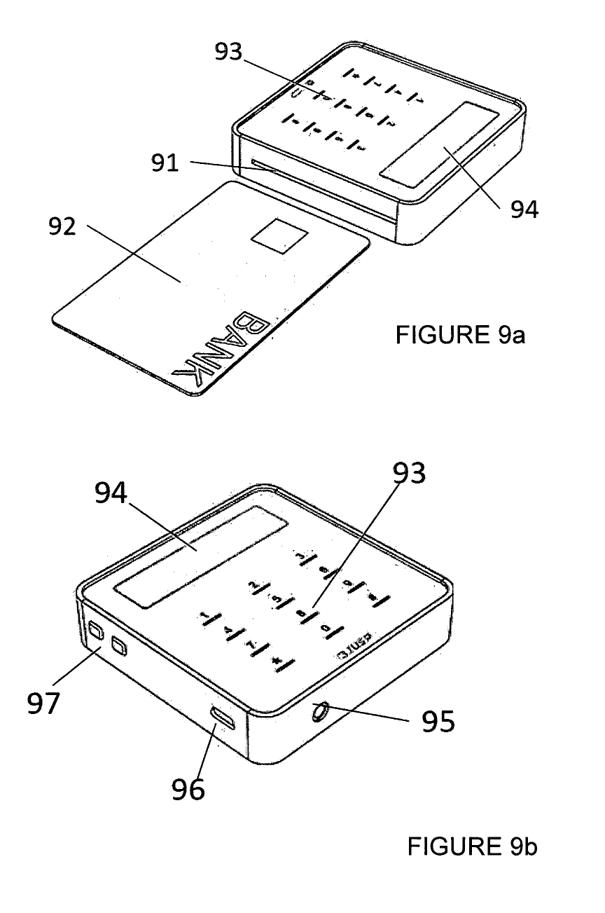

The POS 101 is a battery powered payment terminal for transactions through credit or debit chip cards. It is provided with a 12-key secure keypad (FIG. 9a, 9b) for entering the pin and it is in compliance with EMVL1, EMVL2, PCI3.1 ABI2 standards.

The POS has a display of the monochromatic oled technology (OLED MONO) with a size of 2 inches. The oled technology allows low consumptions and a wide viewing angle and a good resolution of displayed information to be provided.

The POS for the communication to other devices and for the routing of the payment transaction uses a USB interface or an audio interface. The terminal is also provided with a MICRO-USB connector on which it is possible to open an emulated serial connection and to recharge the lithium polymer battery pack that powers it.

The data on the audio interface are modulated with the FSK technique, below in details, such to be transferred to an external device that locally completes them as regards the amount exchange or it sends them via internet connection to a bank server.

The POS has two processors inside it: a security processor (SECURE PROCESSOR) and a processor that manages the FSK modulation and demodulation (FSK MODEM).

The secure processor is of the Arm SC100 type, with operating system and security manager, and it manages the control of the peripheral devices that are directly involved in the payment process, such as smart card driver, keypad, display, tamper and mesh.

The secure processor and the relevant peripheral devices are enclosed in a secure area, provided with a cover for the circuits for sealing them and for avoiding tampering.

The secure processor interfaces with a processor of the Cortex M0 type that acts as FSK modulator/demodulator of the digital packets to be transferred from and to the audio port.

More in particular, the circuit of FIG. 8 further comprises the following components:
BUZZER: audio signalling device of the magnetic type for completing the interface to the user.
XTAL 32 Khz: quartz oscillator required by the system real time clock and by the security block of the secure processor;
XTAL 6 Mhz: quartz oscillator of the secure processor able to generate the base frequency, then it is multiplied by the internal PLL;
SMC connector: card connection element (smart card);
DRIVER: of TDA8035 type, it is a circuit able to adapt levels and timing of power up and power down of the power towards the card;
KEYBOARD: keyboard
2×Mesh: wired two-pole networks placed in the printed circuits composing the device such to prevent areas with sensitive components from being tampered from the outside;
4×Tamper: switches placed inside secure areas, where the secure processor is comprised, for detecting intrusion from the outside or the removal/substitution of parts/components located in the secure area. The intervention of a tamper or a mesh causes the master key of the terminal to be cancelled and so it causes it not to be used anymore;
NOR FLASH, SRAM, DATA FLASH: service memories;
LDO: circuits able to adapt the voltage level and to stabilize it as required by the integrated circuits to which they are connected: they are of the type with low voltage drop-out between input and output;
MAIN BATTERY, BATTERY CHARGER, battery and relevant charger of the POS;
MICRO USB: micro-usb connector;
SCROLL UP/DOWN: scroll buttons for the modem;
RING DETECT: detector for the connection request by the mobile device;
AUDIO JACK: audio jack
OPAMP: input and output audio signal amplifiers.

The state of up/down keys is transferred in transparency to the secure processor by signal repetition on ports of the “gpio” type. The depression of the up key for more than 5 seconds causes the device to shut off The update of both the processors is made also by the USB port.

The audio circuit, joined to a 4-way 3.5 mm audio jack connector, with level and impedance matched, enters the analog circuit (ADC and DAC) of the cortex MO processor.

The POS has been designed for allowing it to be used with any mobile device. As it can be noted in FIGS. 9a and 9b, it is provided with a slot 91 for inserting the credit or debit card 92.

It is provided with a keypad 93, a display 94, an audio port 95, a micro-USB port 96, up-down scroll buttons 97, described above.

As also in FIG. 1, from the functional perspective, the data acquisition and management system (104) is implemented also by a software embedded in the POS.

The POS and the mobile device, for data exchange, use a USB type interface (106) or preferably a packet organization and a suitable FSK (frequency shift keying) encoding of the audio signal, described in detail below, through the audio port and a jack connector (107).

The choice of this type of modulation, instead of other ones, is due to the easiness and simplicity of this algorithm that is able to be managed by substantially all the sound cards on the market.

Thus the technical solution of the present invention can be implemented on any device having an audio jack.

The POS and the mobile device are provided with modules for audio encoding and decoding (107, 108); moreover the mobile device is provided with a system for acquiring data through USB (109) and with a user interface (103, 110).

Another component, described below, in the mobile device, handles the transactions (111), which manages also a bi-directional connection between the POS and a service management server (112). The server provides the messages of the transactions of the required services to a functional block called terminal manager (113). These communications occur in compliance with the EMV standard stated above, in a manner known per se.

A database (114) is connected to the server for tracing statistics and information useful for the owner of the mobile device.

The mobile device can be of any type, provided that it is equipped with an audio port. For example it can be any smart-phone or tablet computer provided with Android, iOs and Windows Phone 7 operating system.

As an alternative to the mobile device, it is possible to use a non-portable device such as a personal computer or terminal, equipped with an audio port, able to manage information coming from the POS and to communicate with the server in charge of the interfacing with terminal manager.

The modules shown in FIG. 1 inside the mobile device (102) for example are made as elements of a single application provided in the memory of the device.

The user interface 103 provided on the POS for example is such as shown in FIGS. 9a and 9b, therefore, as said, it is composed of an alphanumeric keypad, for example of the touch-screen type, and of a display for displaying information about the transaction.

The POS 101 described in FIG. 1 as already said is configured in order to read smart-cards by following the EMV standard. The technical and design features will be described below.

The signal exchanged between the mobile device and the POS is organized in packets and therefore it is modulated with FSK modulation.

An example of the structure of the sent packets is the following:

| SOH | ADD | CMD | LEN | PKT | CRC |
|---|---|---|---|---|---|
| 0x02 | Address | CMD | Len | packet | CRC |
| | 1 byte | 1 Byte | 2 bytes | | 2 Bytes |

The meaning of the packet fields is as it follows:
SOH = 0x02 start of the packet
ADD = Address, it means the logic origin of the packet
CMD = means the type of message
LEN = two bytes that denote the size of the packet
PKT = payload, transported packet
CRC = 16 bit check CRC of the packet

The ADD address field particularly may denote a message exchange between smart-phone and mobile device, or between mobile device and server.

The part sending a packet indicates the address. The part that receives the packet shall confirm the successful reception by an ACK packet, or the unsuccessful reception by a NACK packet: thus the two managers guarantee the transport and they manage NACK, ACK or timeout.

If ACK or NACK is not received within the time-out time, the packet is sent again.

The error detection method used for transmitting packets, is CRC-16, CCITT standard, that prevents the length of the data packets from increasing.

FSK is the most common digital modulation on high radio frequencies. Data are transported by the frequency shifting of a sinusoidal wave. In its most simple arrangement the signal can shift in a discrete manner between two frequencies so called space (corresponding to 0, for example 3 Khz) and mark (corresponding to 1, for example 7 Khz). The time necessary for transmitting an individual bit is called bit period. Its inverse gives the transmission rate often measured in bauds or bps. The bit period is bound by the used frequencies that in turn are bound by the sampling frequency of the apparatuses in communication.

FSK coding can be coherent or non-coherent.

The signal generated in a coherent manner is similar to that produced by passing in a discrete manner from the mark to the space frequency.

The phase continuity condition of FSK modulation (glitch free) forces, in the coherent case, to have a relation between the shift and the bit period.

The non-coherent FSK allows more freedom to be provided in selecting the parameters but it is more error-sensitive.

The FSK can be used in synchronous or asynchronous manner.

The reception and decoding methods are based on the frequency-detection technique.

The frequency-detection can operate by demodulation both in the time domain and in frequency domain.

If a demodulation algorithm operating in the frequency domain is used, it is preferable to use band-pass filters, for isolating the frequencies of interest in the input signal and for rejecting possible noises thereon. Once the filters are applied, the demodulator decides whether the analyzed signal corresponds to a 1 or to a zero.

These methods have a high computational complexity than those operating in the time domain but they are more resistant against disturbances.

A particular care is used in windowing the signal (type of window, dimension).

A possible implementation of the demodulation algorithm operating in the frequency domain provides the following steps:

(a) monitoring the signal till it exceeds the value of an empirically defined threshold: if so, go on;

(b) signal acquisition and windowing;

(c) filtering the signal with band-pass filter around the mark frequency;

(d) filtering the signal with band-pass filter around the space frequency;

(e) comparing the two filtered signals and determining bits;

(f) repeating steps b, c, d till the signal is below the mentioned threshold, otherwise go to f;

(g) reconstructing the received binary code.

On the contrary in case of using a demodulation algorithm operating in the time domain, there are several approaches for frequency recognition and demodulation problem.

For the demodulation in the time domain it is preferable to window the signal with a window having a dimension lower than the bit period and a further lower step for minimizing the errors (for example window ½ long and step ⅓ of the bit period). Once the signal is analyzed and bits are extracted it is necessary to consider these details for reconstructing the sent binary code.

A possible implementation of the demodulation algorithm operating in the time domain provides the following steps:

(a) monitoring the signal till it exceeds the value of an empirically defined threshold; in this case, go on;

(b) signal acquisition and windowing;

(c) going on with the binary discrimination rule (described below);

(d) repeating steps b and c till the signal is below the mentioned threshold, otherwise go to a (e);

(e) reconstructing the binary code received considering the dimension of the window and of the windowing step.

Binary discrimination rules are different depending on the analysis tool used. A list of the most used tools and respective possible implementations are as it follows.
Peak detection:

(a) analyzing the signal till it exceeds one of two empirically defined thresholds (a negative one and a positive one).

(b) waiting for the signal to cross again the threshold paying attention to sudden changes in the signal that can deceive the algorithm;

(c) once the threshold is crossed, analyzing the changes in the slope of the signal between the two crossings and extracting the maximum point. If several slope ranges are detected, the mean is made between the two samples that denote that the threshold has been crossed;

(d) make sure that the peak found at the previous step has a higher amplitude than the previous peaks, otherwise reject it;

(e) make sure that the peak has changed polarity: if so, replacing the previous peak with the current one, otherwise simply add the peak to the list;

(f) depending on the number of peaks defined, estimating the frequency of the analyzed signal and assigning a 1 or a 0.
A similar approach is the zero-crossing rate. In this case the number of time the signal crosses the zero is defined and not the peaks. Again this number defines the bit to be assigned.
Other methods use the cross-correlation as a tool for recognizing the frequency of the signal under analysis.

The cross-correlation is used as a measure of similarity. An intuitive explanation thereof is as follows: it is the integral of the product of a signal x by a signal y shifted on the time axis by an amount i. The process is repeated for each possible value of i. When the two signals (the first one and the delayed one) are similar, the cross-correlation value for that specific value of i is maximized.

Analytically:

$$r ( i ) = {\sum }_{m = - ∞}^{∞} {y ( n )}^{*} \cdot x ( n - i )$$

By using this tool with x=y reference is made to autocorrelation. The autocorrelation gives a measure of the period of the signal under examination and therefore of the frequency. In a different manner it is possible to use the signal to be analyzed as y and two sinusoids at mark and space frequencies as x. The maximum value between the two correlations defines the bit associated to the signal.

The methods mentioned above have a very low complexity, but are sensitive to errors on the signal. In order to avoid errors it is possible to use in series pass-band filters that comprises mark and space frequencies.

The system of the invention allows financial transactions in motion to be carried out but it can be used also instead of conventional POS.

A common use can be between two subjects defined below as customer and retailer. The retailer is the owner of the POS and of the mobile device on which the application is installed. The customer is the owner of the card on which the transaction will be charged.

The retailer has an interface (110) provided by the application installed on his/her own mobile device that allows him/her to enter the amount of the transaction and further information about the operation. The term entering the amount means both a direct and indirect entry by the selection of products associated to the retailer. Now the customer has to enter the security code of the card on the interface provided in the POS after having inserted the card in the apparatus.

The application carries out the transaction and it shows the result both to the retailer and to the customer.

If necessary, the customer will be asked to sign by an acquisition system provided on the application.

The list of products associated to the retailer is in the database (114) and it can be modified and updated by the user interface (110).

The privacy of the customer is protected during all the transaction: information entered in the system is encrypted and they directly go to the computer without passing by the user interface of the application; moreover the interfaces are divided (one for the customer and one for the retailer).

Moreover a receipt of the transaction is issued and it is given to the customer according to the selected mode.

Some information of the transaction, non-sensitive ones, is captured by the database (114) for statistics that can be consulted, as already said, by the application interface (110).

The mobile device communicates with the central server (112) through a communication network that uses a protocol such as for example the TCP/IP protocol. Network of such type can be for example interne, Wi-Fi and mobile communication networks (3G, 4G etc.).

Below the operations made by the software application of the invention are described.

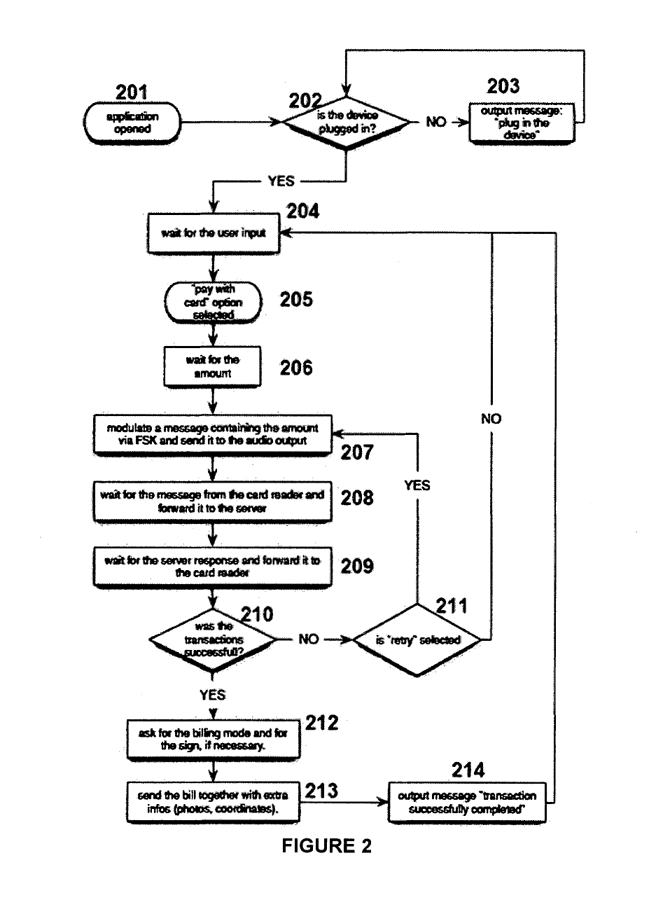

With reference to FIG. 2 it describes the flow chart of the operations performed by the application provided in the smart-phone or mobile device during the transaction.

Upon the opening of the application (Block 201—Application opened), it checks whether the POS is plugged in (Block 202—is the device plugged in?).

If not, the application outputs a negative message (Block 203—output message: “plug in the device”).

If the POS is plugged in, the application waits for an input from the user (Block 204—wait for the user input).

When the user starts to select the use option for the POS (Block 205—“pay with card” option selected), the application waits for the amount input (Block 206—wait for the amount).

After inserting the card, it prepares a FSK modulated message and it sends it to the audio output (Block 207—modulate a message containing the amount via FSK and send it to the audio output).

Then the application starts the communication with the POS and the server (Block 208—wait for the message from the POS and forward it to the server), (Block 209—wait for the server response and forward it to the POS).

Therefore after entering the amount the application sends, by FSK modulation, a message containing the information just acquired. Now it waits for the message from the POS to be forwarded to the server that later will forward it to the terminal manager. Then it waits for the server response and forwards it to the POS.

At the end it checks whether the transaction has been performed successfully (Block 210—was the transactions successful?). If not, it checks whether the user decides to retry (Block 211—is “retry” selected). If not, it goes back at the above step 204. If so, it goes back to the above step 207.

On the contrary if the transaction has been successfully performed, it asks to choose the billing mode and the signature if necessary (Block 212—ask for the billing mode and for the sign, if necessary).

At the end of the procedure it formats the bill and sends it, with additional information, if any, such as photos, bank coordinates, etc. . . . (Block 213—send the bill together with extra infos (photos, coordinates).

Then it generates an output message for the transaction successfully completed (Block 214—output message “transaction successfully completed”).

Then it goes back to step 204 waiting for another input by the user.

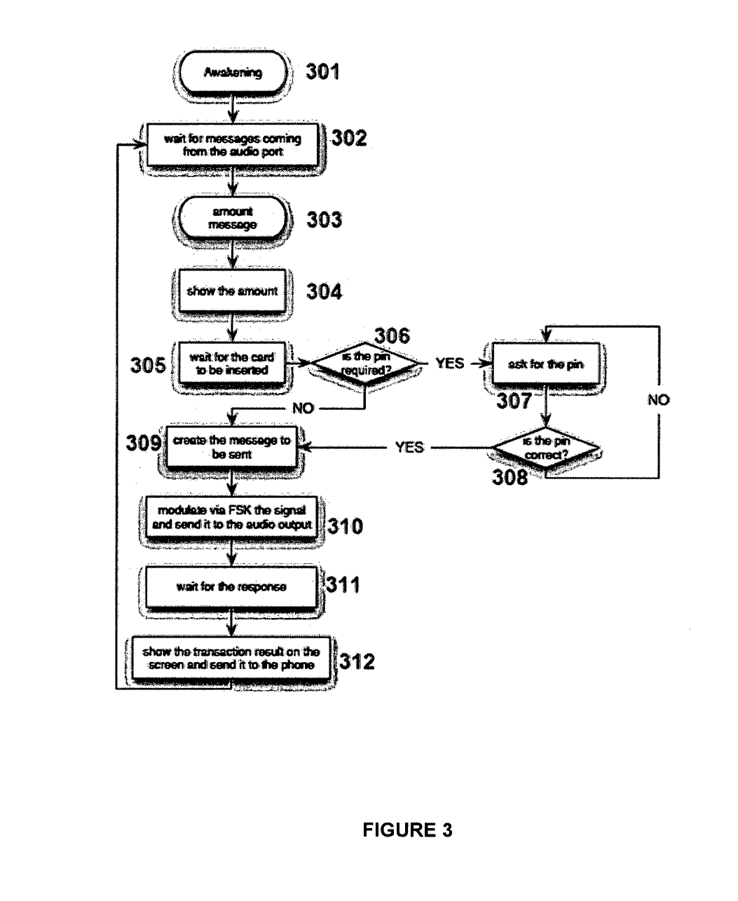

FIG. 3 describes the flow chart of the operations performed by the POS in one transaction.

Firstly the POS is awaken (Block 301—Awakening).

Then it waits for a message coming from the audio port (Block 302—wait for messages coming from the audio port).

Then the POS listens to the audio port (Block 303—amount message). In addition it displays the amount (Block 304—show the amount).

If it receives a message with the amount to be paid then it is arranged for waiting for the card to be inserted (Block 305—wait for the card to be inserted).

If a recognition PIN is required to be entered (Block 306—is the pin required?), it requires the PIN (Block 307—ask for the pin). Then is handles the entry of the PIN by checking whether it is correct (Block 308—is the pin correct?).

At the end of the PIN entry, it creates the message containing the amount to be sent to the mobile device (Block 309—create the message to be sent).

Therefore it modulates the message via FSK and sends it to the audio output (Block 310—modulate via FSK the signal and send it to the audio output).

Then it is arranged for waiting the response from the mobile device (Block 311—wait for the response), and then it shows on the display the result and sends the message to the mobile device (Block 312—show the transaction result on the screen and send it to the phone).

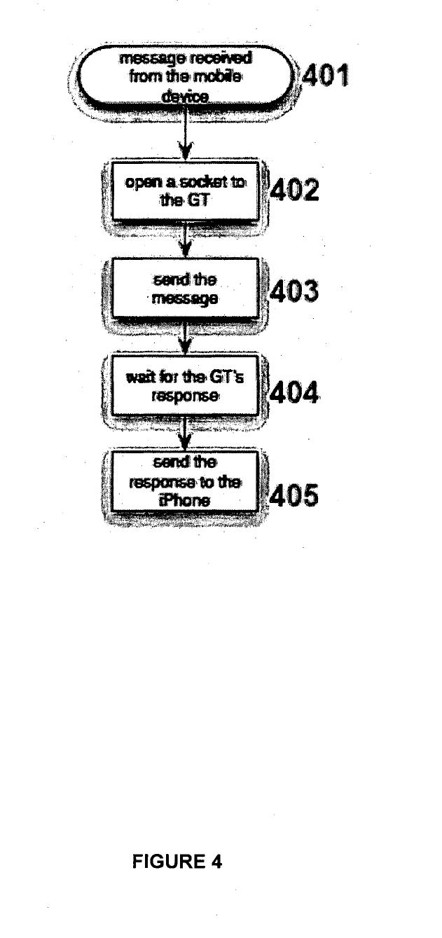

FIG. 4 describes the flow chart of the operations performed by the server in order to handle the communication with the mobile device.

When the server notices that the mobile device is sending a message to it (Block 401—message received from the mobile device), it opens a conversation with the manager of the terminals (Block 402—open a socket to the GT).

Then it sends the message to the terminal manager (Block 403—send the message).

Then it waits for the response from the terminal manager (Block 404—wait for the GT's response).

Finally it sends a response message to the mobile device (Block 405—send the response to the iPhone).

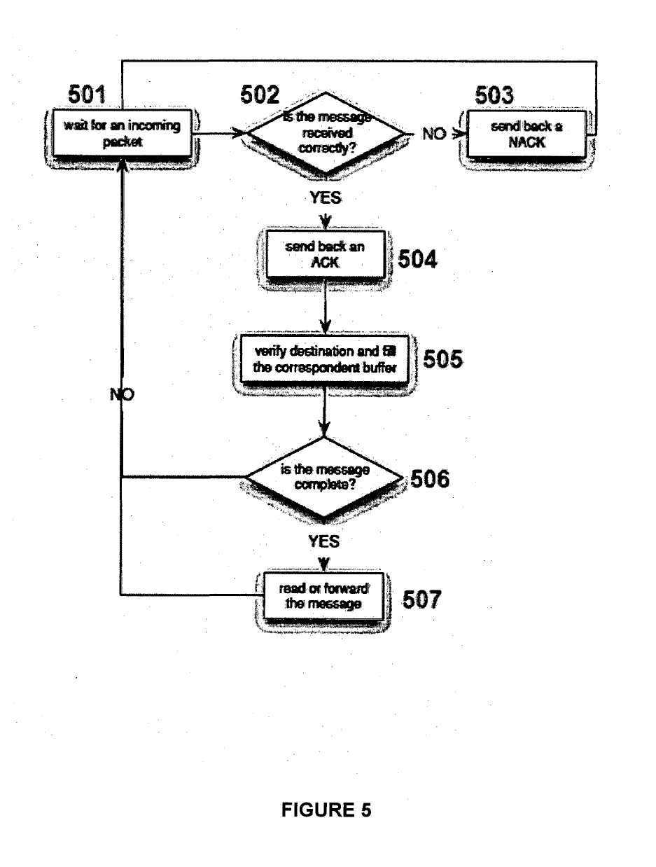

FIG. 5 describes the flow chart of the procedure for receiving messages through audio port on the mobile device side. The communication occurs by packets in order to facilitate and to make the sending of messages more quick if some errors should occur. The initial condition is waiting for a packet of the message to be received (Block 501—wait for an incoming packet)

Upon receiving the message it checks whether the reception is correct (Block 502—is the message received correctly?).

If it is not correct it sends a non-correctness recognition signal to the POS (Block 503—send back a NACK). If on the contrary it is correct, it sends a correctness recognition signal to the POS (Block 504—send back an ACK).

Then it verifies whether the destination is correct and it fills the correspondent buffer (Block 505—verify destination and fill the correspondent buffer). The destination defines the object to which the message has to be forwarded. It can be the device itself or the terminal manager.

When the message is complete (Block 506—is the message complete?) it reads or sends the message (Block 507—read or forward the message), then it goes back at the start (step 501), otherwise it waits for another packet till the packets of the message finish going back at step 501.

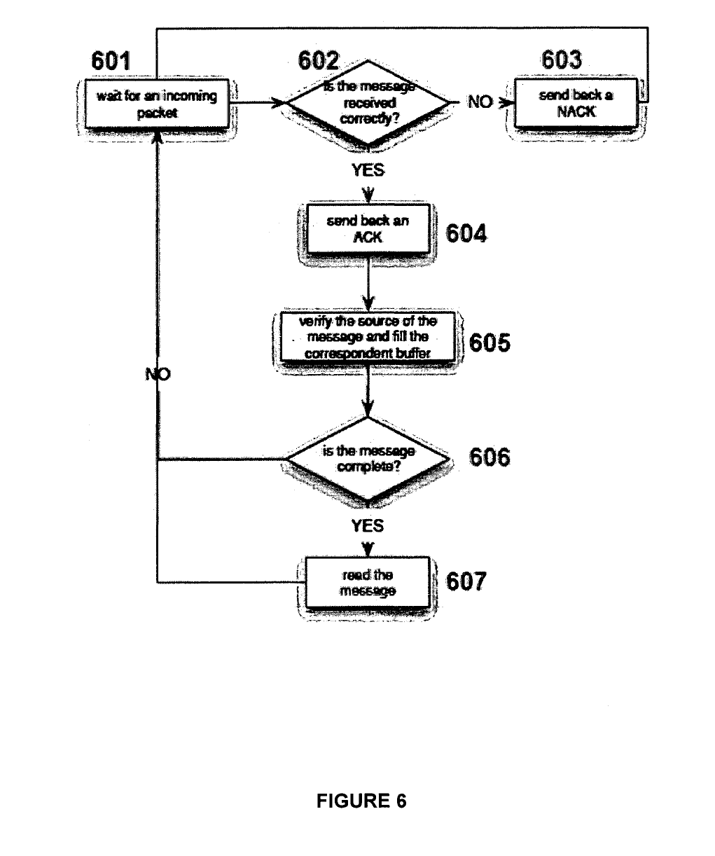

FIG. 6 describes the flow chart of the procedure for receiving the messages through audio port on the card POS side, similar and perfectly symmetrical to the previous one. The initial condition is that of waiting for the reception of a packet of the message (Block 601—wait for an incoming packet)

Upon receiving the message it checks whether the reception is correct (Block 602—is the message received correctly?).

If it is not correct it sends a non-correctness recognition signal to the POS (Block 603—send back a NACK). If on the contrary it is correct it sends a correctness recognition signal to the POS (Block 604—send back an ACK).

Then it verifies whether the source of the message is correct and it correspondent fills the buffer (Block 605—verify the source of the message and fill the correspondent buffer). The source defines the message sender, it can be the POS or the mobile device.

When the message is complete (Block 606—is the message complete?) it reads or sends the message (Block 607—read or forward the message), then it goes back at the start (step 601), otherwise it waits for another packet till the packets of the message finish going back at step 601.

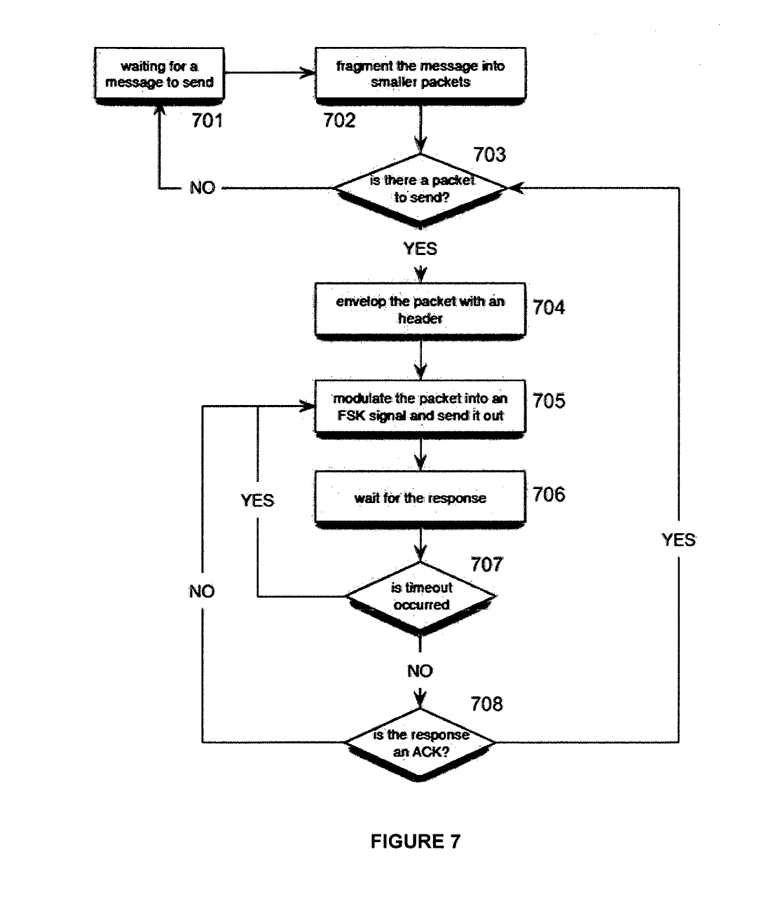

FIG. 7 describes the flow chart of the procedure for sending messages via audio both on smart-phone side and POS side.

The initial condition is that of waiting for a message to transmit (Block 701—waiting for a message to send).

Then the message is organized in packets (Block 702—fragment the message into smaller packets).

Then it is arranged for sending packets one after the other (Block 703—is there a packet to send?), by adding to each packet a header according to what described above (Block 704—envelop the packet with an header). Moreover each packet is FSK modulated and it is sent out (Block 705—modulate the packet into an FSK signal and send it out).

For each packet it carries out iteratively the following procedure going back for each packet at step 703.

It waits for the response of the other receiving part (Block 706—wait for the response), and it verifies whether the time-out has occurred (Block 707—is time-out occurred?)

It verifies the correct recognition of the message waiting for the reception of a positive ACK message or a negative NACK message, by means of the procedure described above (Block 708—is the response an ACK?). If the reception is not correct, it asks for re-transmission going back at step 705, otherwise it goes back at step 703, till the packets of the message finish.

The present invention can be advantageously implemented by a computer program that comprises code means for performing one or more steps of the method, when this program is run on a computer. Therefore the scope of protection is intended to be extended to said computer program and in addition to computer readable media that comprise a recorded message, said computer readable media comprising program code means for performing one or more step of the method, when said program is run on a computer.

It is possible to provide variant embodiments to the non-limiting example described, without departing from the scope of protection of the present invention, including all the equivalent embodiments for a person skilled in the art.

From the description disclosed above the person skilled in the art is able of achieving the object of the invention without introducing any further structural details.

1. A POS apparatus for managing transactions through credit or debit cards, which comprises a POS for said credit or debit cards, adapted to be connected to a terminal via an audio channel of said terminal, the apparatus comprising:
means for reading said credit or debit cards of the EMV type;
at least one user interface for entering secret codes, transaction amounts, and for displaying said amounts;
means for processing transaction-related data, through packet organization, and for bidirectional transmission via said audio channel;
at least one processing unit, placed in an anti-tamper secure area, for said transactions which is also adapted to handle a connection to a central management server; and
means for encrypting said data.

2. The apparatus according to claim 1, wherein said user interface comprises a display of the monochromatic OLED type and a 12-key secure keypad.

3. The apparatus according to claim 1, comprising USB interface means between said POS and said terminal.

4. The apparatus according to claim 1, wherein said anti-tamper secure area comprises wired two-pole networks of the MESH type, switches of the TAMPER type, adapted to detect intrusion from the outside or removal/substitution of parts/components located in the secure area.

5. The apparatus according to claim 1, wherein said means for processing data are configured for performing a FSK modulation of said data.

6. A method for managing transactions through credit or debit cards by means of an apparatus according to claim 1, said method comprising the steps of:
managing the communication between said POS for said credit or debit cards and said terminal via said audio channel of said terminal;
processing said transaction-related data, comprising secret codes, transaction amounts, through packet organization and bidirectional transmission via said audio channel;
entering transaction amounts into said terminal, and displaying said amounts on said POS; and
entering secret codes into said POS.

7. The method according to claim 6, wherein the processing of said data comprises a FSK modulation of said data.

8. (canceled)
